(19) United States
(12) Patent Application Publication
(10) Pub. No.: US 2010/0044966 A1
(43) Pub. Date: Feb. 25, 2010

(54) COUPLING GUARD SYSTEM

(75) Inventors: Kevin M. Majot, Little Genessee, NY (US); Charles A. Rohrs, Allegany, NY (US)

Correspondence Address: HAYNES AND BOONE, LLP;IP Section, 2323 Victory Avenue, Suite 700, Dallas, TX, 75219, US

(73) Assignee: Dresser-Rand Company, Olean, NY (US)

(21) Appl. No.: 12/441,903

(22) PCT Filed: Sep. 25, 2007
(86) PCT No.: PCT/US07/79352

§ 371 Date: Apr. 15, 2009

Related U.S. Application Data
(60) Provisional application No. 60/826,805, filed on Sep. 25, 2006.

(51) Int. Cl. F16J 15/34

(52) U.S. Cl. 277/345

(57) ABSTRACT

A guard system for a coupling that connects a first component to a second component in a pressurized machinery system includes a coupling guard moveable between an open position, which allows access to an internal region of the coupling, and a closed position, which forms a seal surrounding the coupling from the first component to the second component. The system also includes a guide for directing movement of the coupling guard.

### CROSS-REFERENCE TO RELATED APPLICATION

This application claims priority to U.S. Provisional Patent Application No. 60/826,805, entitled “Coupling Guard System”, filed Sep. 25, 2006 by Kevin Michael Majot and Charles Alan Rohrs, the entire contents of which is hereby incorporated by reference.

### BACKGROUND

The present invention relates to connection members for components of pressure containing machinery and, more particularly, a coupling guard system for protecting and sealing an interior region of a coupling between components of the pressure containing machinery.

In existing close-coupled pressure containing machinery, the pressure containing device and structural support are combined into one unit. Historically, access to a coupling and its components has been limited due to generally small access ports in an outer casing of the coupling, which are provided for maintenance access. Combining the pressure sealing and structural support components leads to difficulty creating and maintaining a sealing surface between the co-joined equipment when sealing to contain low mole weight gasses.

### SUMMARY

In one embodiment, the invention provides a guard system for a coupling that connects a first component to a second component in a pressurized machinery system. The guard system includes a coupling guard moveable between an open position, which allows access to an internal region of the coupling, and a closed position, which forms a seal surrounding the coupling from the first component to the second component. The guard system also includes a guide for directing movement of the coupling guard.

In another embodiment, the invention provides a guard system including a coupling guard moveable between an open position, which allows access to an internal region of the coupling, and a closed position, which forms a seal surrounding the coupling from the first component to the second component. A guide for directing movement of the coupling guard extends between the first component and the second component wherein the coupling guard is moveably coupled to the guide. An adjuster is coupled to the coupling guard for adjusting a position of the coupling guard relative to the guide.

In yet another embodiment, the invention provides a pressure containing coupling guard system for connecting a compressor casing to a drive casing in an industrial compression system. The coupling guard system includes a coupling guard moveable between an open position, which allows access to an internal region between the casings, and a closed position, which forms a seal surrounding the internal region. The coupling guard includes sealing surfaces comprising at least one radial sealing surface at one axial end of the coupling guard and at least one circumferential sealing surface at one axial end of the coupling. The system also includes a guide for directing axial movement of the coupling guard, wherein the guide has a slide bar extending between the compressor casing and the drive casing for aligning the coupling guard to at least one of the casings, and an adjuster for adjusting positioning of the coupling guard on the slide bar.

Other aspects of the invention will become apparent by consideration of the detailed description and accompanying drawings.

### BRIEF DESCRIPTION OF THE DRAWINGS

FIG. 1 is a perspective view of a close-coupled pressure containing machinery.

FIG. 2 is a perspective view of the machinery shown in FIG. 1, including a coupling guard system according to one embodiment of the invention and in a closed position.

FIG. 3 is a perspective view of the machinery shown in FIG. 1, including the coupling guard system shown in FIG. 2 in an open position.

FIG. 4A is an end view of a coupling guard that is part of the coupling guard system shown in FIG. 2.

FIG. 4B is a sectional view of the coupling guard taken along line 4B-4B of FIG. 4A.

FIG. 5 is a perspective view of a slide adjuster that is part of the coupling guard system shown in FIG. 2.

FIG. 6 is a perspective view of a slide guide that is part of the coupling guard system shown in FIG. 2.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

For example, terms like “central”, “upper”, “lower”, “front”, “rear”, and the like are only used to simplify the description of the present invention and do not alone indicate or imply that the device or element referred to must have a particular orientation. The elements of the retractable pressure containing coupling guard system referred to in the present invention can be installed and operated in any orientation desired. In addition, terms such as, “first”, “second”, and “third” are used herein for the purpose of description and are not intended to indicate or imply relative importance or significance.

### DETAILED DESCRIPTION

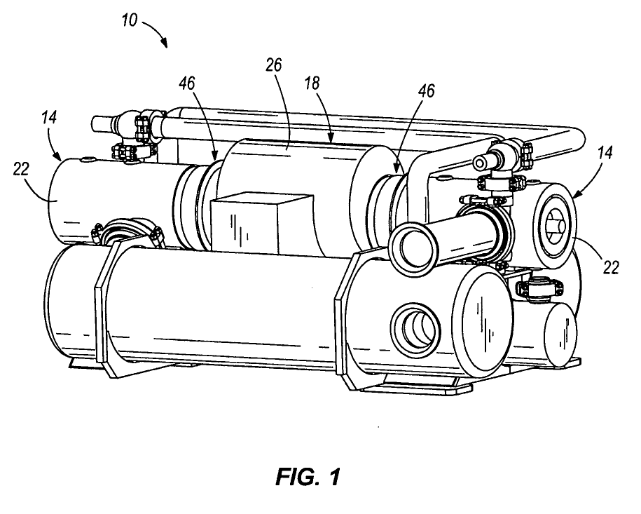

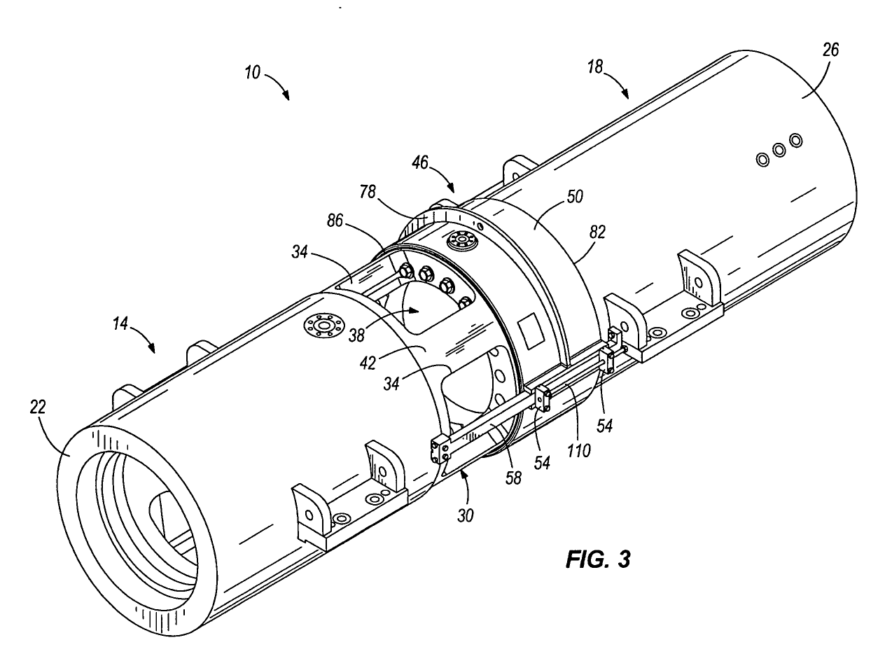

FIG. 1 illustrates a close-coupled pressure containing machinery system of a type that is suitable for use with the present invention. In FIG. 1 there is specifically shown an industrial compression system 10, which is used in industry to compress gasses or fluids for industrial purposes. The system 10 might, for example, be used on an oil drilling platform or an oil production platform. The industrial compression system 10 includes two compressors 14 close-coupled to a double-ended electric motor drive 18. This arrangement allows for a compact design with significant benefits over more traditional base-plate mounted compressor trains. Each compressor 14 is surrounded by a cylindrical compressor casing 22 and the motor 18 is surrounded by a cylindrical motor casing 26. The compressor casing 22 and the motor casing 26 are separate bodies that are positioned to facilitate installation and removal of components. The compressor casing 22 and the motor casing 26 are connected together with a coupling 30 (FIG. 3), which separates pressure containing components and provides a mechanical support structure for connecting the casings 22, 26.

Referring to FIG. 3, the coupling 30 includes access ports 34. The ports 34 provide openings to facilitate removal of bearings, seals, gears, electrical connections and other components within an interior region 38 of the coupling 30 while the electrical drive 18 and the compressor 14 remain connected together. The coupling 30 is attached to the compressor casing 22 and the motor casing 26 with an attachment structure that resists various forces thereon. In the illustrated embodiment, a main case attachment structure 42, or casing, includes threaded studs and nuts for coupling 30 the coupling to the motor casing 26, and the like may be used for coupling the coupling 30 to the compressor casing 22. Other means of mechanical attachment may be employed such as shear rings or other commonly used attachment structures. The attachment structure 42 should be sufficiently sound structurally to prevent separation, vibration, disattachment, torquing or other problems in the integrity of the attachment of the compressor casing 22 to the motor casing 26.

In the illustrated embodiment, a coupling guard system 46 covers the coupling 30 to allow increased maintenance access to the coupling 30 and the associated components while maintaining a high degree of sealed joint integrity. The coupling guard system 46 is a retractable, pressure containing guard system. The coupling guard system 46 separates pressure containing components of the machinery system 10 from structural support components, and maintains a pressure seal over the access ports 34 in the coupling 30. It is desirable that the pressure containing structure 46 is independent of the main structural mechanical connection 30; therefore, a pressure containing sealing surface is not subject to mechanical loads associated with support and operation of the equipment. As an independent structure, the pressure containing sealing surface provides ease of maintenance and sealing integrity.

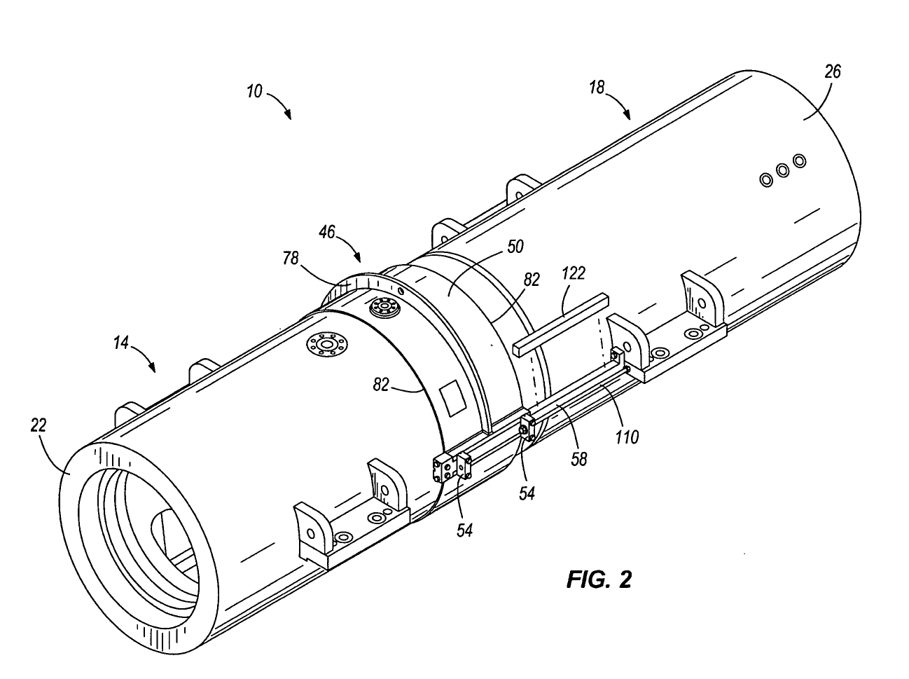

FIG. 2 illustrates the coupling guard system 46 in a closed position to protect the coupling 30, and FIG. 3 illustrates the coupling guard system 46 in an open position to allow access to the coupling 30. In the open position, access to the interior region 38 of the coupling 30 is gained through the ports 34. In the closed position, the ports 34 are covered by a coupling guard 50, or cover, in order to seal the coupling 30 and components contained within the coupling 30. The coupling guard 50 is mounted to the machinery system 10 for axial movement, and may be locked into position to form a sealing surface over the coupling 30.

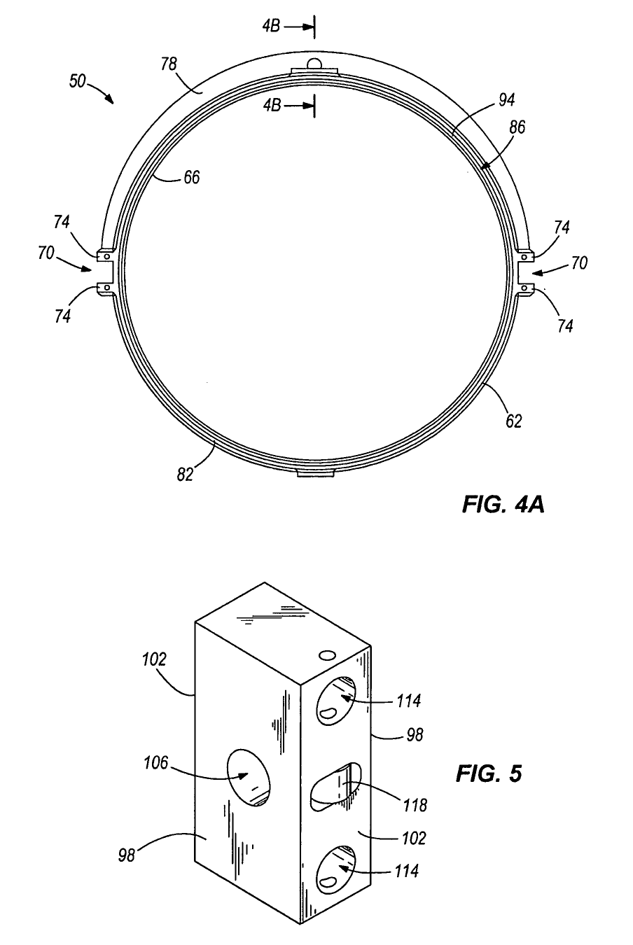

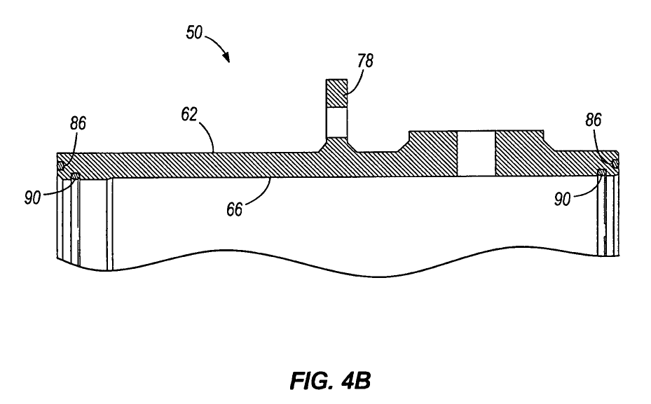

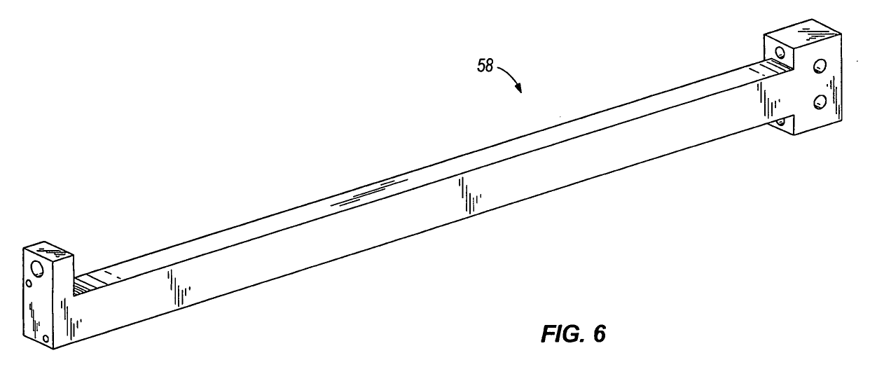

The coupling guard system 46 includes the coupling guard 50 (FIGS. 4A and 4B), two pairs of slide blocks 54 (FIG. 5), or adjusters, and two slide guides 58 (FIG. 6), or bars. The coupling guard 50 is generally cylindrical and includes an exterior surface 62 and an interior surface 66. In the illustrated embodiment, the coupling guard 50 is constructed as a single ring having no bolted joints. The guard 50 includes two slots 70 defined on the exterior surface 62 with the slots 70 spaced approximately 180° apart. For example, one slot 70 is provided at a nine o'clock position and the other slot 70 is at a three o'clock position to control alignment and axial movement of the guard 50. Each slot 70 is defined by a pair of radially extending projections 74, and receives a slide guide 58 for sliding movement thereon. A radially extending flange 78 extends between the first and second slots 70. Structural ribs, lifting lugs, vents, drains and injection connections in the coupling guard 50 may be varied as appropriate and necessary. Any connecting hardware, pattern of openings, construction of casing and direction that the coupling guard retracts may be varied as appropriate or necessary.

At each axial end 82 of the coupling guard 50, sealing members 86, 90 are positioned such that when the coupling guard system 46 is in the closed position, the sealing members 86, 90 operate to prevent pressurized gases from escaping from the interior region 38 of the coupling 30. The sealing members 86, 90 provide a high integrity seal when the coupling guard system 46 is in the closed position. Various locations for the sealing members 86, 90 may be used as long as seal integrity is maintained. In the illustrated embodiment, the coupling guard 50 includes the sealing members 86, 90 or elements to facilitate sealing between the coupling guard system 46, the coupling 30 and the casings 22, 26. Sealing member 86 is positioned on a radial surface at each axial end 82 of the coupling guard 50. Sealing members 90 are positioned on the interior surface 66 of the coupling guard 50 at each axial end 82. In one embodiment, the sealing members 86, 90 each include a groove formed in the surface of the coupling guard 50 and an O-ring 94 received and retained in the groove. The diameter on which each groove is placed is minimally different so as to minimize axial forces exerted on the coupling guard 50 from the pressurized contents. In one embodiment, the sealing members 86, 90 have similar construction in order to minimize axial forces.

As shown in FIGS. 2 and 3, one pair of slide blocks 54 is attached to the projections 74 defining each slot 70. Each slide block 54 (FIG. 5) includes first and second end surfaces 98 and first and second side surfaces 102. An aperture 106 extends through the first and second end surfaces 98 for slidingly receiving a slide bar 110 extending from the motor casing 26 towards the compressor casing 22. The slide bar 110 provides directional guidance to the coupling guard system 46. At least one side surface 102 of the slide block 54 includes a pair of apertures 114 for coupling the block 54 to the coupling guard 50. In the illustrated embodiment, a roller 118 is positioned between the coupling apertures 114 for facilitating sliding movement of the coupling guard 50 along the slide guides 58. The roller 118 is directed toward the slot 70 such the respective slide guide 58 is sandwiched between the coupling guard slot 70 and the slide block 54. The slide blocks 54 are used as a manual slide adjuster to axially move the coupling guard 50 relative to the casings 22, 26. It should be readily apparent to those of skill in the art that other types of friction reducing components, such as low-friction inserts, may be used in the slide blocks 54.

The coupling guard system 46 includes the two slide guides 58 for providing directional guidance and support to the coupling guard 50 in axial movement between the closed position and the open position. Each slide guide 58 extends between the compressor casing 22 and the motor casing 26, as is coupled thereto. In one embodiment, the slide guides 58 may operate as an assembly tool. In still another embodiment, rollers may be provided in the slide guides 58 for facilitating sliding movement of the coupling guard 50. Referring to FIG. 2, a lock block 122 is positioned between the coupling guard 50 and a motor casing end of the slide guide 58 to prevent axial movement of the coupling guard 50 when in the closed position. It should be readily apparent to those of skill in the art that other known locking mechanisms may be used. Further, fewer or more slide guides 58 may be used. Also, other means for positioning and directing movement of the coupling guard 50, such as a linear tab engaging a slot or other type of similar positioning member, may be used.

In FIGS. 2 and 3, only one side of the coupling guard system 46 is shown; therefore, only one pair of slide blocks 54 and one slide guide 58 is shown. The second pair of slide blocks 54 and second slide guide 58 is located on the opposite side of the coupling guard system 46. That is, the slide blocks 54 and slide guides 58 are positioned approximately 180° degrees apart on each side of the coupling guard 50.

Referring to FIG. 2, the retractable pressure containing coupling guard system 46 is shown in a closed position. In the closed position, the sealing members 86, 90 engage mating surfaces on the compressor casing 22 and motor casing 26 to form a sealed enclosure around the coupling 30. A lock block 122 is positioned between the coupling guard 50 and a motor casing end of the slide guide 58 to prevent axial movement of the coupling guard 50. The lock block 122 provides a positive axial stop, while allowing the coupling guard 50 to float on the sealing surfaces 86, 90 as necessary during equipment operation. The lock block 122 is removed or moved to a non-blocking position in order to move the coupling guard system 46 to the open position.

To move the coupling guard system 46 to the open position, a user utilizes the slide blocks 54, or manual slide adjusters, to physically slide the coupling guard 50 along the slide guides 58. Rollers 118 on the slide blocks 54 facilitate sliding movement of the coupling guard 50. In a further embodiment, electric, hydraulic or pneumatic mechanisms may also be employed as a means to slide the coupling guard 50 between the closed position and the open position.

The coupling guard system 46 enables opening and closing of the coupling guard 50 with a simple, convenient process, and provides for ease of maintenance and sealing integrity.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

Since other modifications, changes and substitutions are intended in the foregoing disclosure, it is appropriate that the appended claims be construed broadly and in a manner consistent with the scope of the invention.

1-20. (canceled)

21. A guard system, comprising:
a coupling guard moveable between an open position, wherein the coupling guard allows access to an internal region of a coupling connected to a first component and a second component, and a closed position, wherein the coupling guard forms a seal surrounding the coupling from the first component to the second component; and
a guide coupled to the coupling guard and extending between the first and second components, for directing movement of the coupling guard.

22. The guard system of claim 21, further comprising an adjuster coupled to the coupling guard for adjusting a position of the coupling guard.

23. The guard system of claim 22, wherein the adjuster comprises a roller engaging the guide.

24. The guard system of claim 21, wherein the coupling guard includes an outer circumference, and a first slot formed in the outer circumference and slidably receiving the guide.

25. The guard system of claim 24, wherein the coupling guard further comprises a second slot formed in the outer circumference and positioned 180° around the outer circumference apart from the first slot.

26. The guard system of claim 21, wherein the coupling guard further comprises:
a first axial end located proximal to the first component;
a second axial end located proximal to the second component;
a first radial sealing surface positioned at the first axial end; and
a second radial sealing surface positioned at the second axial end.

27. The guard system of claim 21, further comprising a lock block for maintaining the coupling guard in the closed position.

28. The guard system of claim 27, wherein the lock block is positioned between the coupling guard and the guide.

29. A guard system for a coupling that connects a motor casing and a compressor casing, comprising:
a coupling guard moveable between an open position, which allows access to an internal region of the coupling, and a closed position, in which the coupling guard forms a seal surrounding the coupling;
a guide extending between the motor casing and the compressor casing; and
an adjuster coupled to the coupling guard and slidably engaging the guide, for adjusting a position of the coupling guard relative to the guide.

30. The guard system of claim 29, wherein the coupling guard includes an outer circumference and a pair of slots defined therein, wherein each one of the pair of slots slidably receives the guide.

31. The guard system of claim 29, wherein the adjuster slidably receives the guide through an aperture defined in the adjuster, and includes a roller engaging the guide.

32. The guard system of claim 29, wherein:
the adjuster comprises:
a first slide block including first and second apertures defined therein; and
a second slide block including third and fourth apertures defined therein; and
the guide comprises:
a first slide bar extending through the first and third apertures; and
a second slide bar extending through the second and fourth apertures.

33. The guard system of claim 32, wherein the adjuster further comprises a plurality of rollers, wherein at least one of the plurality of rollers is disposed in each of the first, second, third, and fourth apertures.

34. The guard system of claim 29, wherein the coupling guard further comprises:
an axial end proximal to the compressor casing; and
a radial sealing surface positioned at the axial end, for sealing the coupling guard to the compressor casing when the coupling guard is in the closed position.

35. The guard system of claim 34, further comprising a circumferential sealing surface positioned proximal to the axial end of the coupling guard and radially between the coupling and the coupling guard.

36. A coupling guard system, comprising:
a coupling guard comprising:
a first axial end located proximal to a compressor casing;
a second axial end located proximal to a motor casing;
a radial sealing surface located at the first axial end; and
a circumferential sealing surface located proximal to the first axial end,
wherein the coupling guard is axially moveable between an open position, which allows access to an internal region between the compressor casing and the motor casing, and a closed position, in which the coupling guard forms a seal surrounding the internal region; and
a guide comprising a slide bar extending between the compressor casing and the motor casing, and an adjuster coupled to the slide bar and the coupling guard, for adjusting positioning of the coupling guard on the slide bar.

37. The coupling guard system of claim 36, wherein the guide further comprises a lock block for maintaining the coupling guard in the closed position.

38. The coupling guard system of claim 37, wherein the lock block is positioned between the guide and the compressor casing.

39. The coupling guard system of claim 36, wherein the adjuster further comprises:
an aperture defined therein, through which the slide bar is received; and
a roller engaging the slide bar.

40. The coupling guard system of claim 36, wherein the coupling guard includes an outer circumference and a slot defined therein that slidably receives the slide bar, for movement of the coupling guard on the slide bar.
